(19) United States
(12) Patent Application Publication
(10) Pub. No.: US 2016/0185036 A1
(43) Pub. Date: Jun. 30, 2016

(54) CARTRIDGE, UNIT, AND METHOD FOR MANUFACTURING THE SAME

(71) Applicant: CANON KABUSHIKI KAISHA, Tokyo (JP)

(72) Inventors: Toshiteru Yamasaki, Yokohama-shi (JP); Akira Suzuki, Naka-gun (JP); Nobuharu Hoshi, Yokohama-shi (JP); Akiko Yamasaki, Yokohama-shi (JP)

(21) Appl. No.: 14/979,097

(22) Filed: Dec. 22, 2015

(30) Foreign Application Priority Data
Dec. 25, 2014 (JP) PCT/JP2014/084430

(51) Int. Cl. B29C 65/44; B29C 45/00; G03G 21/18; B29C 45/14

(52) U.S. Cl. CPC B29C 65/44; B29C 45/14; B29C 45/0053; G03G 21/181; B29K 2025/04

(57) ABSTRACT

A cartridge and unit removably attachable to an image forming apparatus, allowing a member for securing a sheet member to be easily mounted with high precision, and capable of preventing leakage of a developing agent and a method for manufacturing the same are provided.

A cleaning unit 2a includes a frame 24 including a waste-toner chamber 30 storing a developing agent eliminated from the image bearing member 21, an end-portion seal member 26a disposed on the frame 24 and being in contact with the image bearing member 21, a scooping sheet 15 including an end arranged on the end-portion seal member 26a and used for preventing the developing agent in the waste-toner chamber 30 from leaking through an area between the frame 24 and the image bearing member 21, and a resin member 10 for securing the scooping sheet 15 to the frame and being injection-molded to the frame 24. The resin forming the resin member 10 is made to enter the end-portion seal member 26a, and the end-portion seal member 26a and the resin member 10 are integrated.

### TECHNICAL FIELD

The present invention relates to a cartridge and unit removably attachable to an electrophotographic image forming apparatus for forming an image on a recording medium and to a method for manufacturing the same.

### BACKGROUND ART

An electrophotographic image forming apparatus using an electrophotographic image forming process (hereinafter referred to as image forming apparatus) conventionally employs a process cartridge technique in which an electrophotographic photosensitive member and processors that act on the electrophotographic photosensitive member are integrated into a unit. With this process cartridge technique, a user can attach a process cartridge (hereinafter referred to as cartridge) to a main body of the image forming apparatus (hereinafter referred to as main body of the apparatus) and remove it therefrom. The user is able to perform maintenance of the image forming apparatus independently of repair people, and this can significantly improve the usability. Accordingly, the process cartridge technique is widely used in image forming apparatuses.

The cartridge is described with reference to FIGS. 24A to 24C. FIG. 24A is a perspective view that illustrates an arrangement of a scooping sheet 203, end-portion seal member 206a, and cleaning container 201 (frame). FIG. 24B is a cross-sectional view taken along XXIVB-XXIVB in FIG. 24A before hot-melt adhesive 207 is applied. FIG. 24C is a cross-sectional view taken along XXIVC-XXIVC in FIG. 24A after the hot-melt adhesive 207 is applied.

Typically, an image forming apparatus repeats steps described below in forming images. First, an electrostatic lament image is formed on an electrophotographic image bearing member (image bearing member) being an image bearing member having a photosensitive layer in its outer circumferential surface. The electrostatic latent image is developed (rendered visible) as an image by a developing agent (toner) conveyed from a developer through a toner container, a development container, and a developing-agent bearing member, and the obtained image is transferred to a transfer material. Toner and other adherents remaining on the surface of the image bearing member after the completion of one image forming step are sufficiently eliminated by a cleaner before the beginning of the next image forming step.

As an example of the cleaner, a cleaning unit including a cleaning blade 205, the scooping sheet 203, the end-portion seal member 206a, and the cleaning container 201 including a waste-toner chamber 200 is known. In this configuration, toner remaining on an image bearing member 202 is scraped off the surface by the cleaning blade 205, the scraped toner is scooped up by the scooping sheet 203, and the scooped toner is collected in the waste-toner chamber 200. To prevent the scraped toner from leaking from the outer circumferential surface of the end portion of the image bearing member 202, the end-portion seal member 206a is arranged on one end of the end portion and an end-portion seal member 206b (not illustrated) is arranged on another end of the end portion. To prevent the toner from leaking through an area between the scooping sheet 203 and the cleaning container 201, double-sided tape 204 for securing the scooping sheet 203 is disposed in contact with the end-portion seal members 206a and 206b.

In that cleaner, a gap i (gap in the thickness direction of the end-portion seal members 206a and 206b) is present between the cleaning container 201 and each of the end-portion seal members 206a and 206b). The gap i between the cleaning container 201 and each of the end-portion seal members 206a and 206b is sealed by applying resin, such as the hot-melt adhesive 207, thereto afterward (see Patent Literature 1).

As described above, to prevent leakage of toner, it is necessary to apply another resin, such as the hot-melt adhesive 207, to the gap between the frame and the end-portion seal member afterward and to affix the double-sided tape 204 with high precision so as not to have a gap between the double-sided tape 204 and each of the end-portion seal members 206a and 206b.

### CITATION LIST

### Patent Literature

PTL 1 Japanese Patent Laid-Open No. 2001-125465

In recent years, in a step of assembling a cartridge by using an automatic machine, there has been a need to improve the production efficiency and manufacturing accuracy for products to further reduce the cost. There has also been a need to miniaturize the cartridge in the image forming apparatus.

However, the method using application of resin, such as hot-melt adhesive, to the gap between the frame and the end-portion seal member afterward has to include two steps, the step of affixing the double-sided tape and the step of applying the hot-melt adhesive. Moreover, in the method using bonding the sheet member to the frame by the double-sided tape, because the double-sided tape is a pliable member, it is difficult to affix the double-sided tape with high precision.

### SUMMARY OF INVENTION

It is an object of the present invention to provide a cartridge and unit removably attachable to an image forming apparatus, allowing a member for securing a sheet member to be easily mounted with high precision, and capable of preventing leakage of a developing agent and a method for manufacturing the same.

A unit according to the present invention includes a frame including a developing-agent containing portion, a rotary member rotatably disposed on the frame, an end-portion seal member disposed on the frame and being in contact with an end portion in a lengthwise direction of the rotary member, a thin plate member disposed along the lengthwise direction and including an end in a direction that crosses the lengthwise direction, the end being arranged on the rotary member, and a resin member that secures the thin plate member to the frame and that is injection-molded to the frame. Resin forming the resin member enters the end-portion seal member, and the end-portion seal member and the resin member are integrated.

A unit manufacturing method for manufacturing a unit according to the present invention relates the unit including a frame including a developing-agent containing portion, a rotary member rotatably disposed on the frame, an end-portion seal member disposed on the frame and being in contact with an end portion in a lengthwise direction of the rotary member, a thin plate member disposed along the lengthwise direction and including an end in a direction that crosses the lengthwise direction, the end being arranged on the rotary member, and a resin member that secures the thin plate member to the frame and that is injection-molded to the frame. The unit manufacturing method includes a first step of arranging the end-portion seal member on the frame, a second step of making a mold come into contact with the frame, injection-molding resin into a space defined by the frame, the end-portion seal member, and the mold, and forming the resin member, a third step of placing the thin plate member on the resin member and bonding the thin plate member to the frame by melting the resin member, and a fourth step of securing the rotary member to the frame. In the second step, resin forming the resin member is made to enter the end-portion seal member, and the end-portion seal member and the resin member are integrated.

Another unit manufacturing method for manufacturing a unit according to the present invention relates to the unit including a frame including a developing-agent containing portion, a rotary member rotatably disposed on the frame, an end-portion seal member disposed on the frame and being in contact with an end portion in a lengthwise direction of the rotary member, a thin plate member disposed along the lengthwise direction and including an end in a direction that crosses the lengthwise direction, the end being arranged on the rotary member, and a resin member that secures the thin plate member to the frame and that is injection-molded to the frame. The unit manufacturing method includes a first step of making a mold come into contact with the frame, injection-molding resin into a space defined by the frame and the mold, and forming the resin member, a second step of placing the end-portion seal member on the frame such that the end-portion seal member is in contact with the resin member, a third step of placing the thin plate member on the resin member and bonding the thin plate member to the frame by melting the resin member, and a fourth step of securing the rotary member to the frame. In the third step, the resin member is melted, resin forming the resin member is made to enter the end-portion seal member, and the end-portion seal member and the resin member are integrated.

Further features of the present invention will become apparent from the following description of exemplary embodiments with reference to the attached drawings.

### BRIEF DESCRIPTION OF DRAWINGS

FIG. 1 is a cross-sectional view that illustrates an overall configuration of an image forming apparatus.

FIG. 2 is a cross-sectional view of a process cartridge according to a first embodiment.

FIG. 3 is a cross-sectional view that illustrates a cleaning member and an image bearing member according to the first embodiment.

FIG. 4 is a cross-sectional view that illustrates a configuration of the cleaning member in a cleaning unit according to the first embodiment.

FIG. 5 is a plan view of the cleaning unit seen from a direction of an arrow V in FIG. 4.

FIG. 6 is a cross-sectional view that illustrates a developing unit according to the first embodiment.

FIG. 7 is a cross-sectional view that illustrates part of the developing unit according to the first embodiment.

FIG. 8 is a plan view seen from a direction of an arrow VIII in FIG. 7.

FIGS. 9A and 9B are perspective views that illustrate a cleaning container according to the first embodiment.

FIGS. 10A to 10C are cross-sectional views that illustrate a step of injection-molding an elastomer member according to the first embodiment.

FIG. 11 is a perspective view that illustrates the step of injection-molding the elastomer member according to the first embodiment.

FIGS. 12A and 12B are illustrations of a configuration of the elastomer member and an end-portion seal member according to the first embodiment.

FIGS. 13A and 13B are illustrations of a configuration of the elastomer member and the end-portion seal member according to a variation of the first embodiment.

FIG. 14 is a perspective view that illustrates the cleaning container with a scooping sheet attached thereto according to the first embodiment.

FIG. 15 is a perspective view for describing how the scooping sheet is positioned according to the first embodiment.

FIG. 16 is a perspective view for describing how the scooping sheet is secured according to the first embodiment.

FIG. 17 is a cross-sectional view taken along XVII-XVII in FIG. 16.

FIG. 18 is a partial enlarged view that illustrates part in FIG. 17.

FIGS. 19A and 19B are illustrations of a configuration of the elastomer member, end-portion seal member, and scooping sheet according to the first embodiment.

FIG. 20 is a cross-sectional view that illustrates a step of injection-molding an elastomer member according to a second embodiment.

FIG. 21 is a plan view that illustrates the elastomer member according to the second embodiment.

FIGS. 22A and 22B are a plan view and a cross-sectional view, respectively, that illustrate a configuration of the elastomer member and end-portion seal member according to the second embodiment.

FIGS. 23A to 23C are illustrations of a configuration of the elastomer member, end-portion seal member, and scooping sheet according to the second embodiment.

FIGS. 24A to 24C are illustrations of part of a cleaning unit in related art.

### DESCRIPTION OF EMBODIMENTS

Embodiments of the present invention are described in detail below with reference to the drawings, and are not intended to limit the present invention. In the following description, a lengthwise direction of a process cartridge is a direction of a rotation axis of an image bearing member. The left and right of the process cartridge are one end side and the other end side in the lengthwise direction. The upper surface of the process cartridge is an upper surface in the state where the process cartridge is installed in a main body of an electrophotographic image forming apparatus, and the lower surface of the process cartridge is a lower surface in that state.

Here, the process cartridge is a cartridge into which an electrophotographic image bearing member and at least one of a charger, developer, and cleaner are integrated such that the cartridge is removably attachable to the main body of the image forming apparatus.

The electrophotographic image forming apparatus forms an image on a recording medium by using the electrophotographic image forming technique. Examples thereof may include an electrophotographic copier, electrophotographic printer (e.g., laser beam printer, LED printer), and facsimile machine.

### First Embodiment

(Configuration of Main Body of Image Forming Apparatus)

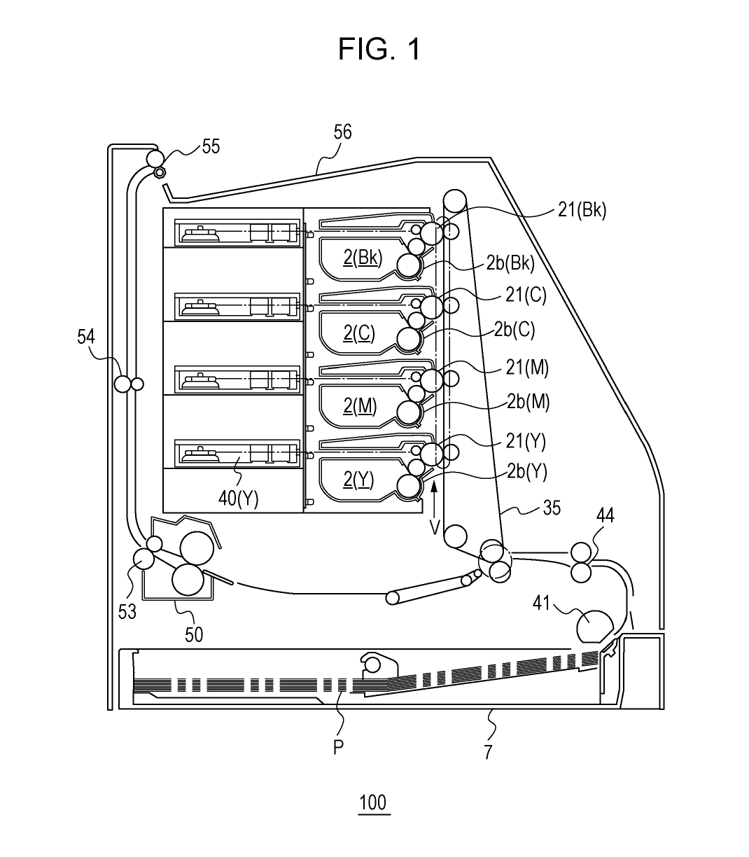

First, a configuration of a main body of an image forming apparatus is described with reference to FIG. 1. FIG. 1 is a schematic cross-sectional view of a color laser beam printer (hereinafter referred to as main body of the image forming apparatus) as one form of the image forming apparatus. A main body of the image forming apparatus 100 includes cartridges 2 corresponding to four colors, an intermediate transfer member 35 for transferring an image developed on image bearing members 21 (rotary member) to a transfer material P, a fixing portion 50 for fixing the image on the transfer material P, and a group of discharge rollers 53 to 55 for discharging the transfer material P to a discharge tray 56. The process cartridges 2 corresponding to four colors (Y, M, C, and Bk) are individually removably attachable to the main body of the image forming apparatus 100.

Next, operations of the main body of the image forming apparatus 100 are described. First, a paper feed roller 41 rotates, separates one from the transfer materials P in a paper feed cassette 7, and conveys it to registration rollers 44. The image bearing member 21 and the intermediate transfer member 35 rotate in the direction of the arrow in FIG. 1 at a predetermined outer circumferential velocity (hereinafter referred to as process velocity V). The surface of each of the image bearing members 21 is uniformly charged by the charger, then exposed by an exposure device 40, and has an electrostatic latent image formed thereon. A developing unit 2b develops the latent image on the image bearing member 21 by using a developing agent (hereinafter referred to as toner). Color images corresponding to Y, M, C, and Bk developed on the image bearing members 21 are primarily transferred to the outer circumferential surface of the intermediate transfer member 35. The color images are secondarily transferred to the transfer material P, and they are fixed on the transfer material P in the fixing portion 50. The transfer material P with the images fixed thereon is discharged onto the discharge tray 56 through the pairs of discharge rollers 53 to 55. The image forming operation is completed.

(Configuration of Cartridge)

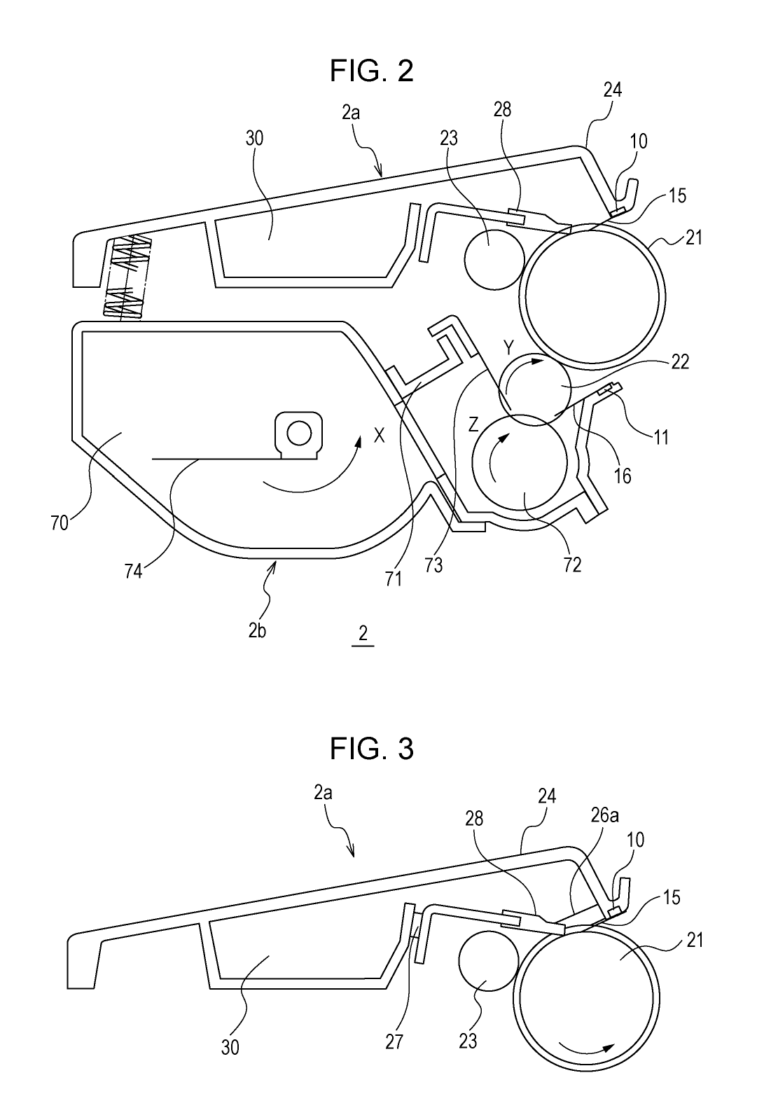

A configuration of the cartridges 2 is described with reference to FIG. 2. FIG. 2 is a schematic cross-sectional view of one of the cartridges 2. The cartridges corresponding to Y, M, C, and Bk have the same configuration. Each of the cartridges 2 is divided into a cleaning unit 2a and the developing unit 2b.

The cleaning unit 2a includes a cleaning container (frame) including a waste-toner chamber 30 (developing-agent containing portion), a charging roller 23, and a cleaning blade 28. The image bearing member 21 is rotatably supported by the cleaning container 24. The charging roller 23, cleaning blade 28, and a scooping sheet 15 are arranged in sequence around the image bearing member 21. The charging roller 23 is a primary charger for uniformly charging the surface of the image bearing member 21. The cleaning blade 28 is used for eliminating the developing agent (toner) remaining on the image bearing member 21. Thus the scooping sheet 15 is arranged such that one end in a direction that crosses the lengthwise direction of the image bearing member 21 is arranged on the image bearing member 21. The scooping sheet 15 is used for scooping the toner eliminated by the cleaning blade 28 and is secured to the cleaning container 24 by an elastomer member 10.

The developing unit 2b includes a developing-agent bearing member 22 (rotary member) being a developer, a toner container 70 (developing-agent containing portion) storing toner, a development container 71, and a supply roller 72. The developing-agent bearing member 22 is supported by the development container 71 such that it can rotate in a direction of an arrow Y. The supply roller 72, a developing-agent regulating member 73, and a blow-off preventing sheet 16 are arranged in sequence around the developing-agent bearing member 22. The supply roller 72 can rotate in a direction of an arrow Z in contact with the developing-agent bearing member 22. The developing-agent regulating member 73 regulates toner, provides a desired amount of electric charge, and forms a predetermined thin toner layer. The blow-off preventing sheet 16 prevents a developing agent from leaking through the gap between the development container 71 and developing-agent bearing member 22 to the outside and is secured by an elastomer member 11 disposed on the development container 71. Thus the blow-off preventing sheet 16 is arranged such that one end in a direction that crosses the lengthwise direction of the developing-agent bearing member 22 is arranged on the developing-agent bearing member 22. A toner stirring mechanism 74 capable of rotating in a direction of an arrow X is disposed inside the toner container 70.

Next, operations of the cartridge 2 are described. First, the toner is conveyed by the toner stirring mechanism 74 to the supply roller 72. The supply roller 72 supplies the toner to the developing-agent bearing member 22 by rotating in the direction of the arrow Z in FIG. 2. The toner supplied onto the developing-agent bearing member 22 is made to reach the development blade unit 73 by rotation of the developing-agent bearing member 22 in the direction of the arrow Y. The development blade unit 73 provides the toner with a desired amount of electric charge and forms a thin toner layer having a predetermined thickness. The toner regulated by the developing-agent regulating member 73 is conveyed to a developing portion where the image bearing member 21 and the developing-agent bearing member 22 are in contact with each other. The electrostatic latent image on the image bearing member 21 is developed by the developing agent by a development bias applied to the developing-agent bearing member 22. After the toner developed on the image bearing member 21 is primarily transferred to the intermediate transfer member 35, waste toner remaining on the image bearing member is eliminated by the cleaning blade 28. The eliminated waste toner is collected in the waste-toner chamber 30.

(Cleaning Unit)

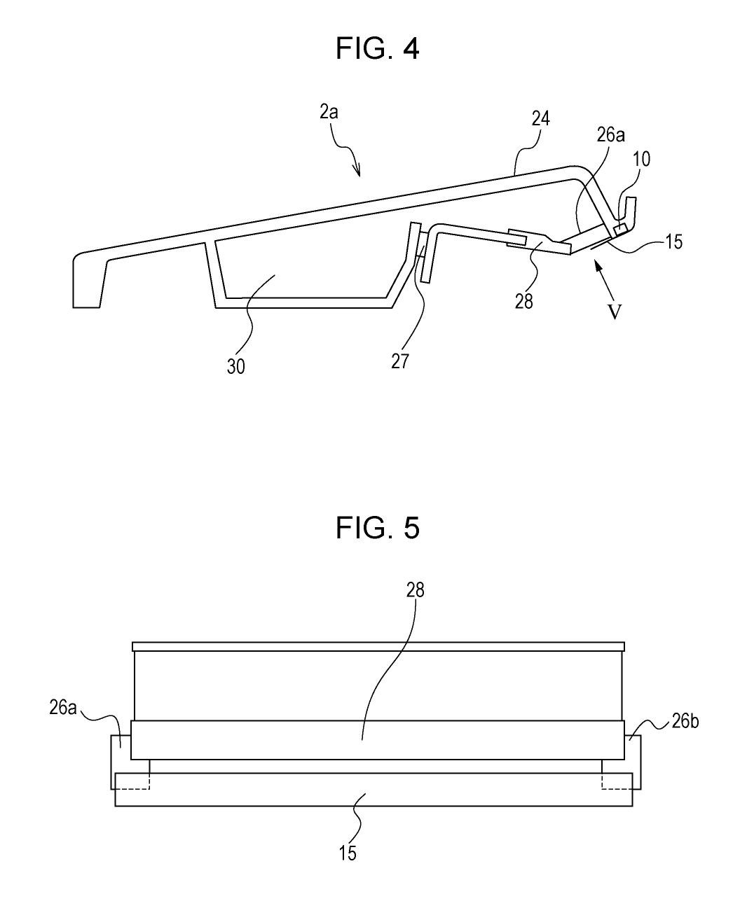

A configuration of the cleaning unit 2a in the present invention is described with reference to FIGS. 3 to 5. FIG. 3 is a schematic cross-sectional view that illustrates the cleaning member and the image bearing member 21. FIG. 4 is a schematic cross-sectional view that illustrates a configuration of the cleaning member. FIG. 5 is an illustration for describing the configuration of the cleaner seen from the direction of the arrow V in FIG. 4.

The cleaning unit 2a includes the cleaning blade 28 for scraping residues, such as waste toner, off the image bearing member 21 the scooping sheet 15 (thin plate member) for scooping the scraped residues, and the charging roller 23 for charging the cleaned image bearing member 21. It also includes the waste-toner chamber 30 for storing the residues on the image bearing member 21, end-portion seal members 26a and 26b arranged on both end portions of the cleaning blade 28 to prevent the residues from leaking from the waste-toner chamber 30, and a cleaning-blade lower seal 27. These members are incorporated in the cleaning container 24, and they constitute the cleaning unit 2a.

Specifically, the cleaning blade 28 and the scooping sheet 15 are in contact with the outer circumferential surface of the image bearing member 21 in locations where both do not interfere with each other. The scooping sheet 15 is secured to the cleaning container 24 with the elastomer member 10 (resin member). The elastomer member 10 is molded such that it enters part of the end-portion seal members 26a and 26b. After that, the scooping sheet 15 is fused to part of the elastomer member 10 by heat (details are described below). The end-portion seal members 26a and 26b are made of a flexible member that includes a fibrous portion and a portion, the fibrous portion being made of a nonwoven fabric, such as felt, of a pile textile in which fibers are woven, of a material formed by electrostatic flocking, or of other similar materials. Thus as the end-portion seal members 26a and 26b, a component including a member in which space is present inside a frame formed by fibers, resin, or other materials is used. The end-portion seal members 26a and 26b collect or scrape waste toner remaining on the outer circumferential surface of the end portion of the image bearing member 21 to prevent the toner from leaking to the outside. The end-portion seal members 26a and 26b are in contact with both end portions of the cleaning blade 28 and the scooping sheet 15, as illustrated in FIG. 5, and are also in contact with the outer circumferential surface of the image bearing member 21, as illustrated in FIG. 3. The cleaning-blade lower seal 27 hermetically seals the gap between the cleaning blade 28 and cleaning container 24.

(Developing Unit)

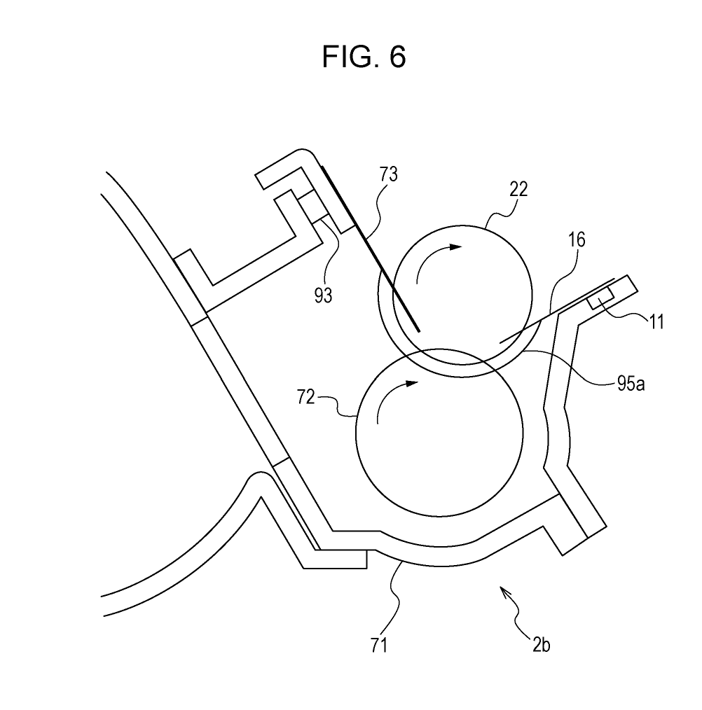

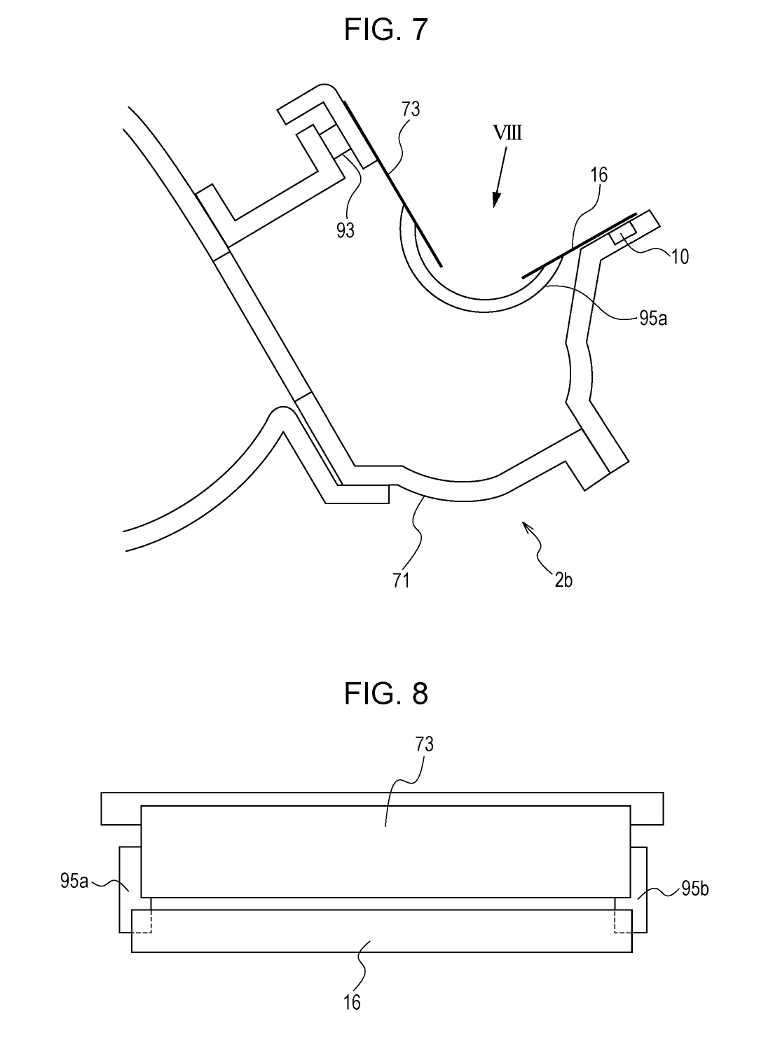

A configuration of the developing unit 2b in the present invention is described with reference to FIGS. 6 to 8. FIG. 6 is a schematic cross-sectional view of the developing unit 2b. FIG. 7 is a schematic cross-sectional view that illustrates a configuration of the blow-off preventing sheet 16 (thin plate member), development blade unit 73, and end-portion seal members 95a and 95b. FIG. 8 is an illustration for describing the configuration seen from the direction of the arrow VIII in FIG. 7.

The developing unit 2b includes the supply roller 72 for supplying toner to the developing-agent bearing member 22, development blade unit 73 for leveling off the toner on the developing-agent bearing member 22, and blow-off preventing sheet 16 for preventing the toner between the developing-agent bearing member 22 and the development container 71 from being blown off. It also includes the development container 71 for storing the toner, end-portion seal members 95a and 95b arranged on both end portions of the development blade unit 73 to prevent the toner from leaking from the development container 71, and a development blade lower seal 93. These members are incorporated into the development container 71, and they constitute the developing unit 2b.

Specifically, the development blade unit 73 and blow-off preventing sheet 16 are in contact with the outer circumferential surface of the developing-agent bearing member 22 in locations where they do not interfere with each other. The blow-off preventing sheet 16 is secured to the development container 71 with the elastomer member 11 (resin member). The elastomer member 11 is molded such that it enters part of the end-portion seal members 95a and 95b. After that, the blow-off preventing sheet 16 is fused to part of the elastomer member 11 by heat (details are described below). The end-portion seal members 95a and 95b are made of a flexible member that includes a fibrous portion and a porous portion, the fibrous portion being made of a nonwoven fabric, such as felt, of a pile textile in which fibers are woven, of a material formed by electrostatic flocking, or of other similar materials. Thus as the end-portion seal members 95a and 95b, a component including a member in which space is present inside a frame formed by fibers, resin, or other materials is used. The end-portion seal members 95a and 95b are in close contact with the outer circumferential surface of the end portion of the developing-agent bearing member 22, collect the toner, and prevent the toner from leaking to the outside. The end-portion seal members 95a and 95b are in contact with both end portions of the development blade unit 73 and blow-off preventing sheet 16, as illustrated in FIG. 8, and are also in contact with the outer circumferential surface of the developing-agent bearing member 22, as illustrated in FIG. 6. The development blade lower seal 93 hermetically seals the gap between the development blade unit 73 and development container 71.

(Molding of Elastomer Member)

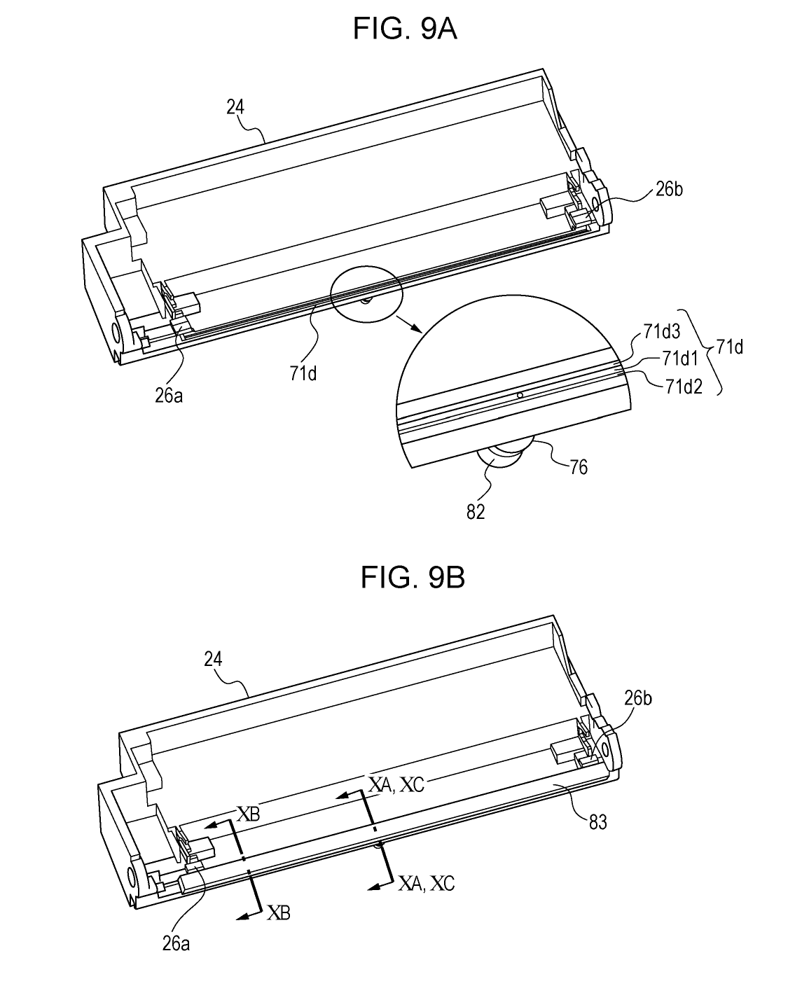

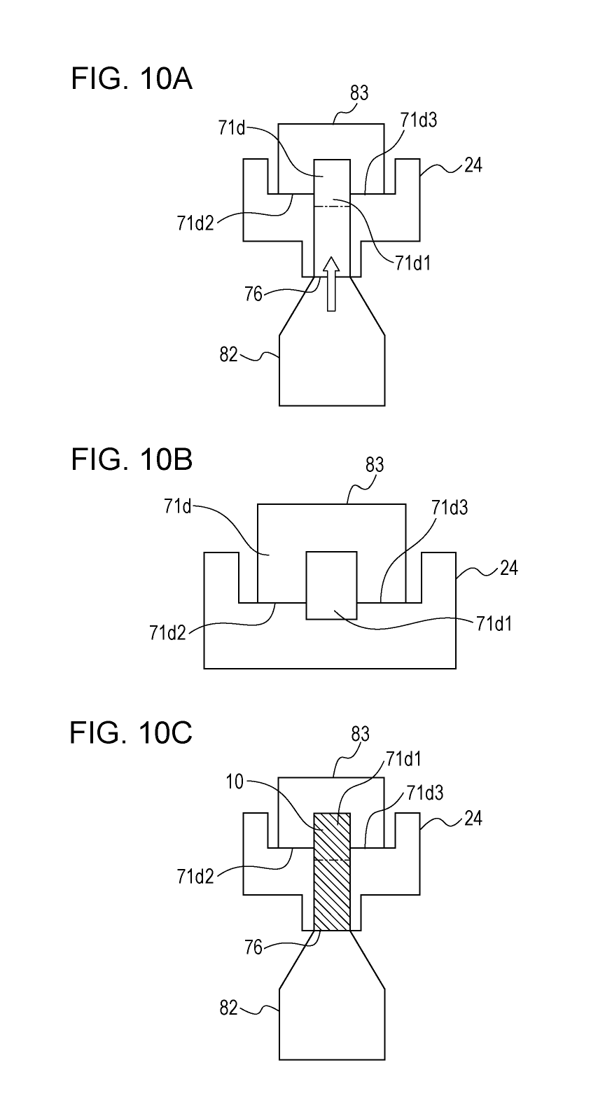

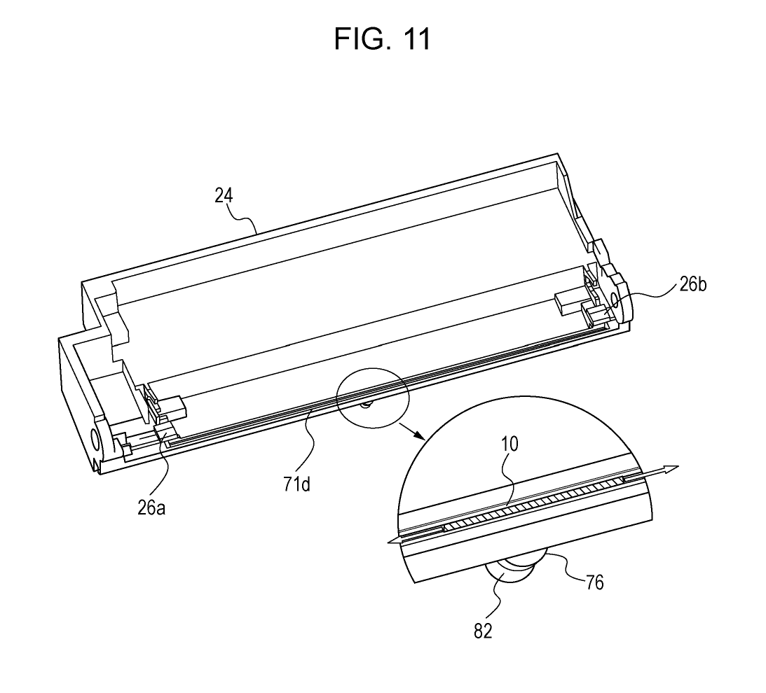

A step of molding the elastomer member 10 is described with reference to FIGS. 9A to 11. FIG. 9A includes a schematic view of the cleaning container 24 and a schematic enlarged view of an inlet portion. FIG. 9B is a schematic view of a state where a mold 83 is clamped in FIG. 9A. FIG. 10A is a schematic cross-sectional view taken along XA-XA in the state illustrated in FIG. 9B. FIG. 10B is a schematic cross-sectional view taken along XB-XB in the state illustrated in FIG. 9B. FIG. 10C is a schematic cross-sectional view taken along XC-XC in the state where the elastomer member 10 is molded in FIG. 9B. FIG. 11 is a schematic view that illustrates the state where the elastomer member 10 is molded in FIG. 9A.

As illustrated in FIGS. 9A to 10C, the end-portion seal member 26a is disposed on an end of the cleaning container 24, the end-portion seal member 26b is disposed on another end thereof, and an elastomer-member forming portion 71d is disposed between the end-portion seal member 26a on one end and the end-portion seal member 26b on the other end. The elastomer-member forming portion 71d has a recess portion 71d1 allowing the elastomer member 10 to be injected therein and includes contact surfaces 71d2 and 71d3 allowing the mold 83 to come into contact therewith. An inlet 76 having a cylindrical shape and communicating with the recess portion 71d1 in the elastomer-member forming portion 71d is disposed in a predetermined location in the lengthwise direction.

Next, how the elastomer member 10 is molded is described.

In molding the elastomer member 10, as illustrated in FIGS. 10A to 10C, the mold 83 cut into the shape of the elastomer member 10 is made to come into contact with the contact surfaces 71d2 and 71d3 in the elastomer-member forming portion 71d in the cleaning container 24. Next, a gate 82 in a resin injection device is made to come into contact with the inlet 76 disposed in one location in the central portion in the lengthwise direction of the cleaning container 24. Then, thermoplastic elastomer resin that is to be the elastomer member 10 is injected from the gate 82 in the resin injection device through the inlet 76 into the cleaning container 24, as indicated as the arrow illustrated in FIG. 10A. In this way, as illustrated in FIG. 10C, the elastomer resin is poured into a space defined by the recess portion 71d1 in the elastomer-member forming portion 71d in the cleaning container 24, the end-portion seal members 26a and 26b, and the mold 83. Then, as illustrated in FIG. 11, the elastomer resin flows from the central portion in the lengthwise direction toward both ends in the lengthwise direction in the space defined by the recess portion 71d1 in the elastomer-member forming portion 71d, the end-portion seal members 26a and 26b, and the mold 83, and the elastomer member 10 is injection-molded.

The elastomer member 10 is molded integrally with the cleaning container 24. In the present embodiment, styrene-based elastomer resin is used as a material of the elastomer member 10. This is because the cleaning container 24 is made of high impact polystyrene (HIPS), the use of a similar material enables recycling the material (crushing into pellets) without disassembling in recycling of a process cartridge. However, any other elastomer resin that has substantially the same mechanical characteristics as those of the above-described material may also be used.

In the present embodiment, the inlet 76 is disposed in one location of the central portion in the lengthwise direction of the elastomer-member forming portion 71d, as illustrated in FIG. 9A. However, the inlets may be disposed in two or more locations.

(Integration of Elastomer Member and End-Portion Seal Member)

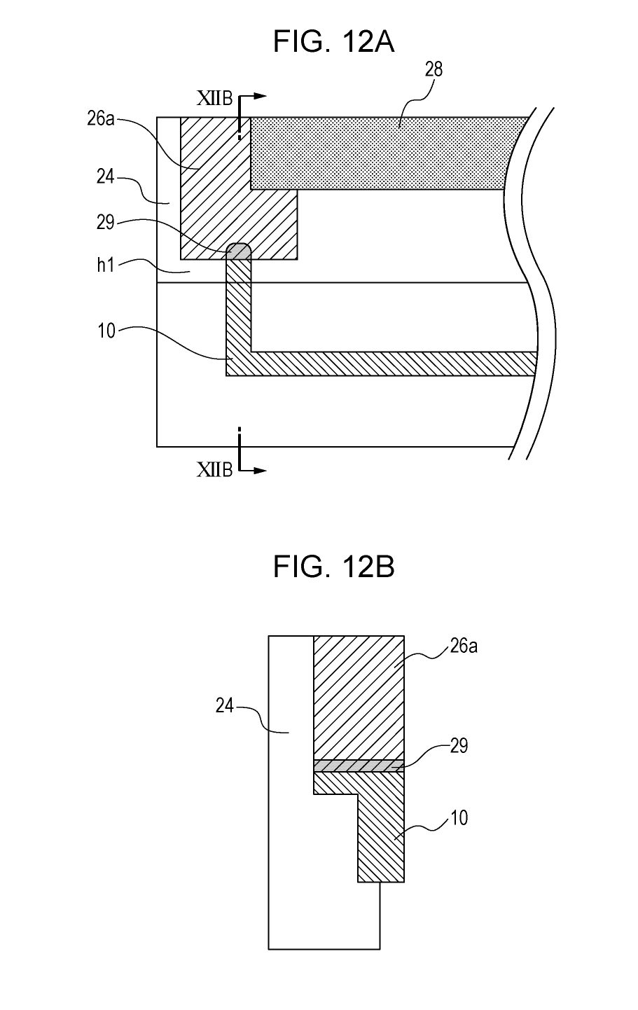

A configuration in which the elastomer member 10 in the present embodiment is molded to the cleaning container 24 and the elastomer member 10 is integrated with the end-portion seal member 26a is described below with reference to FIGS. 12A and 12B. FIG. 12A is a schematic frontal view that illustrates a mixture portion 29 for integrating the elastomer member 10 according to the present embodiment and the end-portion seal member 26a. FIG. 12B is a cross-sectional view illustrating the mixture portion 29, as taken along XIIB-XIIB in FIG. 12A.

In the present embodiment, as illustrated in FIGS. 12A and 12B, the mixture portion 29 is formed by integration made by elastomer resin forming the elastomer member 10 entering part of the end-portion seal member 26a, and this seals a gap h1 between the end-portion seal member 26a and the elastomer member 10. This configuration is described below. As previously described, in the present embodiment, the end-portion seal member 26a is made of a flexible member having a fibrous portion and a porous portion and has a space contained in a frame formed by the fibers, resin, and other elements. In forming the elastomer member 10, thermoplastic elastomer resin that is to be the elastomer member 10 is melted and injected into the elastomer-member forming portion 71d. At this time, the melted thermoplastic elastomer resin that is to be the elastomer member 10 is impregnated into the end-portion seal member 26a, and the mixture portion 29 is formed. That is, the elastomer resin is made to enter the end-portion seal member 26a, i.e., the fibrous portion and porous portion such that the space contained in the frame formed by the fibers, resin, and other elements is filled therewith, and the mixture portion 29 is formed. This integrates the end-portion seal member 26a and the elastomer member 10 and can seal the gap h1. The end-portion seal member 26a on one end and the elastomer member 10 are described with reference to FIGS. 12A and 12B. The end-portion seal member 26b on the other end is integrated with the elastomer member 10 in the same way.

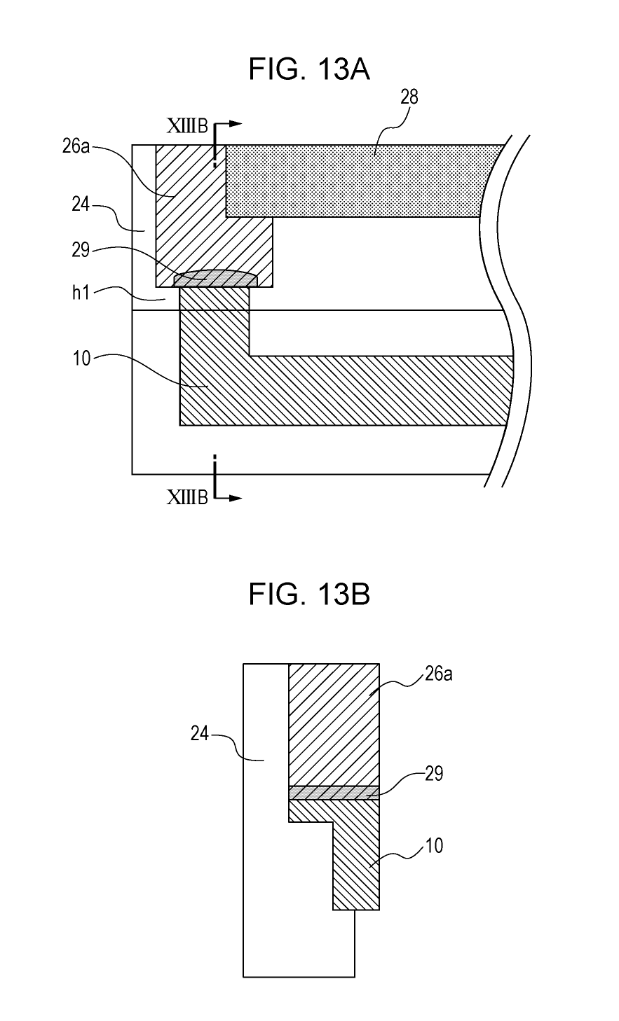

The shape of molding the elastomer member 10 in molding in the present embodiment is only required to have a configuration in which elastomer resin that is to be the elastomer member 10 enter part of the end-portion seal members 26a and 26b and the mixture portion 29 is formed. Thus, aside from the form illustrated in FIGS. 12A and 12B in the present embodiment, as illustrated in FIGS. 13A and 13B, a form in which the width of contact between the end-portion seal member 26a and the elastomer member 10 is increased and the elastomer resin forming the elastomer member 10 further enters the end-portion seal member 26a may also be used. Aside from the configuration in which the mixing portions are disposed on both ends, a configuration in which the mixing portion is disposed on only one end may also be used. In the case where the mixing portions are disposed on both ends, they may not have a shape symmetrical with respect to a plane perpendicular to the lengthwise direction.

(Fusion of Sheet)

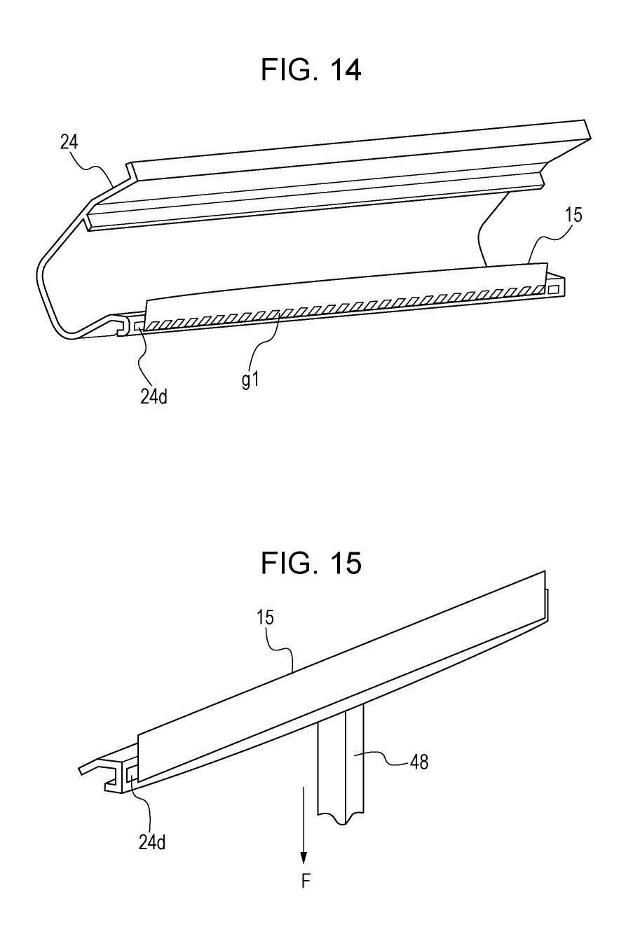

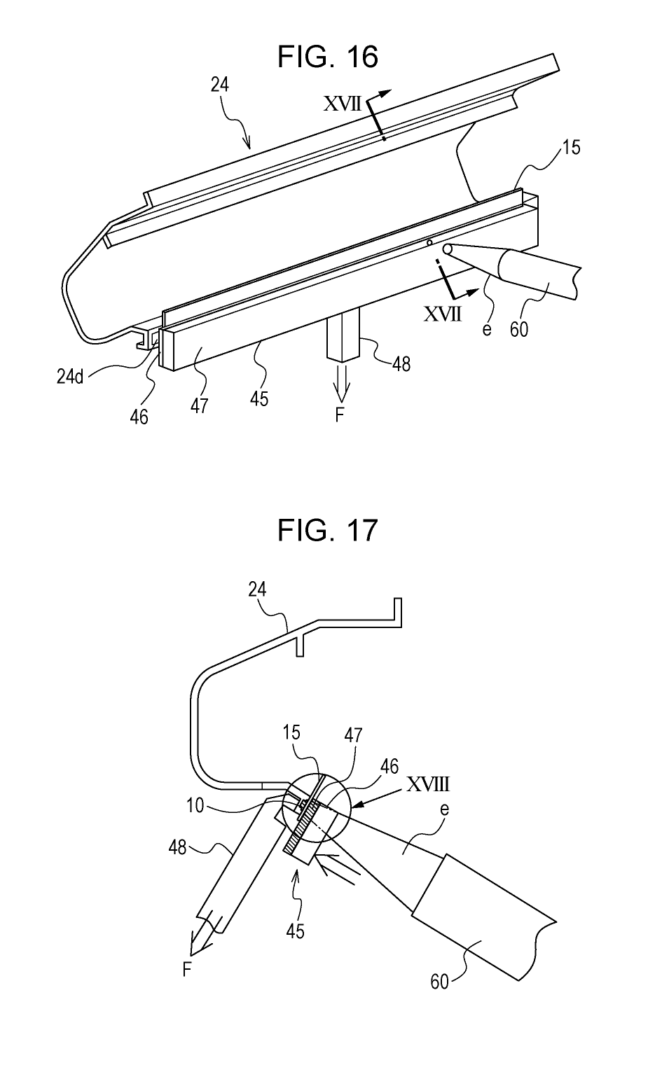

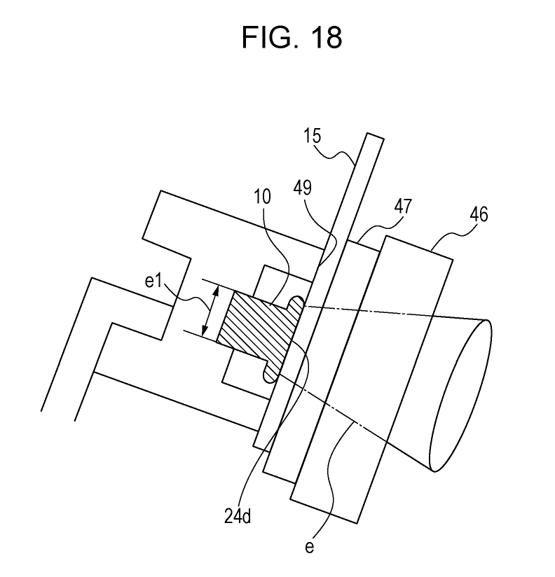

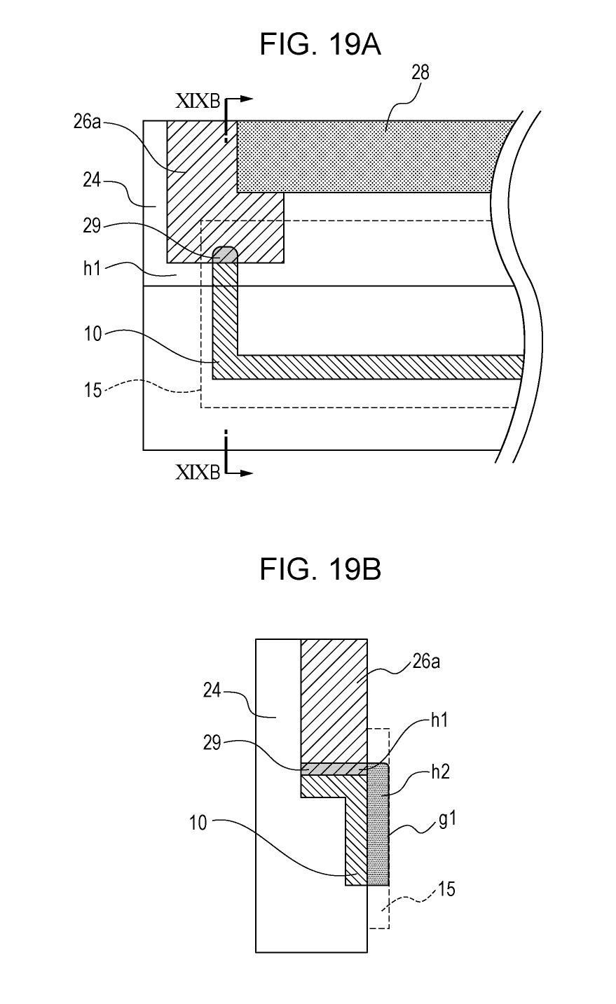

A step of fusing a sheet in the present invention is described by using an example in which a semiconductor laser is employed with reference to FIGS. 14 to 19B. FIG. 14 illustrates the cleaning container 24 with the scooping sheet 15 attached thereto. FIG. 15 is an illustration for describing a step of warping a sheet-member attaching surface 24d in the cleaning container 24 with a pull jig 48 and positioning the scooping sheet. FIG. 16 is an illustration for describing a step of melting the elastomer member 10 molded to the cleaning container 24 and fusing the scooping sheet 15. FIG. 17 is a cross-sectional view taken along XVII-XVII in FIG. 16. FIG. 18 is a partial enlarged view of FIG. 17. FIG. 19A illustrates a fused state of the cleaning container 24 and an end portion of the scooping sheet 15. FIG. 19B is a cross-sectional view taken along XIXB-XIXB in FIG. 19A.

First, the cleaning container 24 is prepared. At this time, a wrinkle of the scooping sheet, environmental change, or other factor may cause an undulation in a leading end (contact portion with the image bearing member 21) of the scooping sheet 15. To address it, in attaching the scooping sheet 15, as illustrated in FIG. 15, a force receiving portion of the sheet-member attaching surface 24d in the cleaning container 24 is pulled downward (F) with the pull jig 48. In this way, the sheet-member attaching surface 24d is warped by elastic deformation.

The scooping sheet 15 is overlaid on the warped sheet-member attaching surface 24d so as to be in contact therewith. They are pressed from above the scooping sheet 15 such that the scooping sheet 15 is in contact with the sheet-member attaching surface 24d by using a press jig 45 having transmittance to near infrared radiation. Specifically, the sheet-member attaching surface 24d is defined by the elastomer member 10 and a regulation surface 49, the scooping sheet 15 is pressed by the press jig 45, and the elastomer member 10 is thus elastically deformed, the scooping sheet 15 is supported by the regulation surface 49 and positioned. In this way, in bonding the scooping sheet 15, it is temporarily positioned so as to avoid that relative arrangement displacement of the scooping sheet 15 with respect to the cleaning container 24.

After that, as illustrated in FIGS. 16 to 18, the scooping sheet 15 is attached in the state where the sheet-member attaching surface 24d is warped. Specifically, laser light e of near infrared rays is emitted from a laser emitting head 60 toward the sheet-member attaching surface 24d in the elastomer member 10 molded to the cleaning container 24 through the scooping sheet 15. The elastomer member 10 contains carbon black to absorb near infrared rays. Thus the emitted laser light e passes through the press jig 45 and the scooping sheet 15, which have transmittance to near infrared radiation, and is absorbed in the sheet-member attaching surface 24d in the elastomer member 10 molded to the cleaning container 24. The laser light e absorbed in the sheet-member attaching surface 24d is converted into heat, the sheet-member attaching surface 24d generates heat, the heat melts the elastomer member 10, and it is fused (bonded) to the scooping sheet 15 in contact with the sheet-member attaching surface 24d.

At this time, as illustrated in FIGS. 19A and 19B, the scooping sheet 15 is fused to up to part of the mixture portion 29 along the elastomer member 10, and the scooping sheet 15 and the end-portion seal member 26a are also bonded together. Similarly, the scooping sheet 15 is fused to the end-portion seal member 26b on the other end by using the elastomer member 10, and the scooping sheet 15 and the end-portion seal member 26b are bonded together too. This fusion can eliminate a gap h2 between the scooping sheet 15 and the cleaning container 24. In addition, fusing the scooping sheet 15 to up to part of the mixture portion 29 causes the elastomer member 10 to be melted again by the heat generated in the fusion and can further improve the state of the adhesion to the end-portion seal members 26a and 26b.

As illustrated in FIG. 18, the laser light e emitted from the emitting head 60 is focused such that it has a circular shape with a diameter of φ1.5 mm when it reaches the sheet-member attaching surface 24d. That is, the spot diameter of the laser is φ1.5 mm. By setting the width of molding the elastomer member 10 at less than 1.5 mm, the sheet-member attaching surface 24d in the elastomer member 10 can be uniformly melted. In the present embodiment, a width e1 of fusing the elastomer member 10 is approximately 1.0 mm. The laser light e is continuously emitted from one end portion of the scooping sheet 15 to the other end portion in its lengthwise direction. In this way, a fused surface g1 being continuous in the lengthwise direction, as illustrated in FIG. 14, is obtainable.

After the scooping sheet 15 is affixed, when the pull jig 48 is detached, elasticity of the sheet-member attaching surface 24d provides tension to the leading end of the scooping sheet 15, and this can reduce the occurrence of undulations. In this way, the attachment of the scooping sheet 15 to the cleaning container 24 is completed.

In the present embodiment, as the scooping sheet 15, a polyester sheet having the thickness 38 μm and the light transmittance 85% (to near infrared rays of 960 nm) is used. As the elastomer member 10, a member in which 3.0 parts by weight of carbon black of average grain size 16 nm are contained with respect to 100 parts by weight of styrene-based elastomer resin is used. As the press jig 45, a member in which elastic silicone rubber 47 (thickness 5 mm) is affixed to a rigid acrylic member 46 with light-transmitting double-sided tape is used. The member used as the press jig 45 allows the wavelength of the laser light e to pass therethrough and has rigidity at which it can press the overall area of the contact surface between the scooping sheet 15 and the sheet-member attaching surface 24d in the elastomer member 10 molded to the cleaning container 24. Specifically, acrylic resin, glass, or other material may be used. Moreover, it is suitable that the press jig 45 may include a member allowing the wavelength of the laser light e to pass therethrough and having elasticity to make the scooping sheet 15 be in closer contact with the cleaning container 24, in addition to the rigid material. As a device for emitting near infrared radiation, FD 200 (wavelength: 960 nm) of Fine Device Co., Ltd. is used, the scanning speed of the near infrared radiation emitting device in the lengthwise direction is 50 mm/sec, the output is 20 W, and the spot diameter at the surface of the elastomer member is φ1.5 mm. The energy density at the surface of the elastomer member 10 is 0.22 J/mm².

In the present embodiment, the case where a laser is used in fusion is described. Other forms may also be used. For example, the elastomer member 10 and the scooping sheet 15 may be fused by heat-sealing. If the elastomer member 10 has sufficient stickiness, the scooping sheet 15 may be pressed as it is and affixed.

Then, the image bearing member 21 is rotatably attached to the cleaning container 24 with the scooping sheet 15 attached thereto. After the cleaning unit 2a is formed, the developing unit 2b is integrated. In this way, the cartridge 2 can be manufactured.

(Advantages)

In the configuration according to the present embodiment, because the elastomer member 10 is directly injection-molded to the cleaning container 24 by using a mold, it can be formed with high precision. In related art, double-side tape is used as a bonding member, and it is difficult to affix the double-side tape, which is an elastic member, to the cleaning container 24 with high precision. In contrast, in the present embodiment, because the elastomer member 10 is directly molded to the cleaning container 24 by using a mold, the elastomer member 10 can be formed on the cleaning container 24 with high positioning precision through a simple step.

In the present embodiment, because the mixture portion 29 is formed such that the elastomer member 10 and the end-portion seal members 26a and 26b are integrated, the gap h1 between the cleaning container 24 and the end-portion seal members 26a and 26b can be sealed. In addition, the adhesion between the elastomer member 10 and the end-portion seal members 26a and 26b can be improved. In related art, another member, such as hot-melt adhesive, is applied to seal the gap h1 between the cleaning container 24 and the end-portion seal members 26a and 26b. In contrast, in the configuration according to the present embodiment, the gap h1 between the cleaning container 24 and the end-portion seal members 26a and 26b can be sealed by forming the mixture portion 29, the sealing of toner can be enhanced, and the step of applying another member, such as hot-melt adhesive, can be omitted.

In addition, in the present embodiment, the mixture portion 29, in which the elastomer resin forming the elastomer member 10 enters part of the end-portion seal members 26a and 26b, and the scooping sheet 15 are bonded without forming the gap h1 between the cleaning container 24 and the end-portion seal members 26a and 26b. In this way, the gap h2 between the scooping sheet 15 and the end-portion seal members 26a and 26b can be avoided, and toner leakage can be prevented more effectively.

### Second Embodiment

In the first embodiment, after the end-portion seal members 26a and 26b are attached to the cleaning container 24, the elastomer member 10 is molded, the mixture portion 29 is formed in the end-portion seal members 26a and 26b, and the end-portion seal members 26a and 26b and the elastomer member 10 are integrated. Other forms may also be used. A configuration in which after the elastomer member 10 is molded to the cleaning container 24 and then the end-portion seal members 26a and 26b are attached, the mixture portion 29 is formed in the end-portion seal members 26a and 26b, and the end-portion seal members 26a and 26b and the elastomer member 10 are integrated may also be used. In the present embodiment, a configuration in which after the elastomer member 10 is molded to the cleaning container 24, the elastomer member 10 is radiated with the laser light e, and the mixture portion 29 is formed in the end-portion seal members 26a and 26b is described below. In the following description, differences from the first embodiment are mainly described. The components common to those in the first embodiment have the same reference numerals, and the portions common to those in the first embodiment are not described here.

(Molding of Elastomer Member)

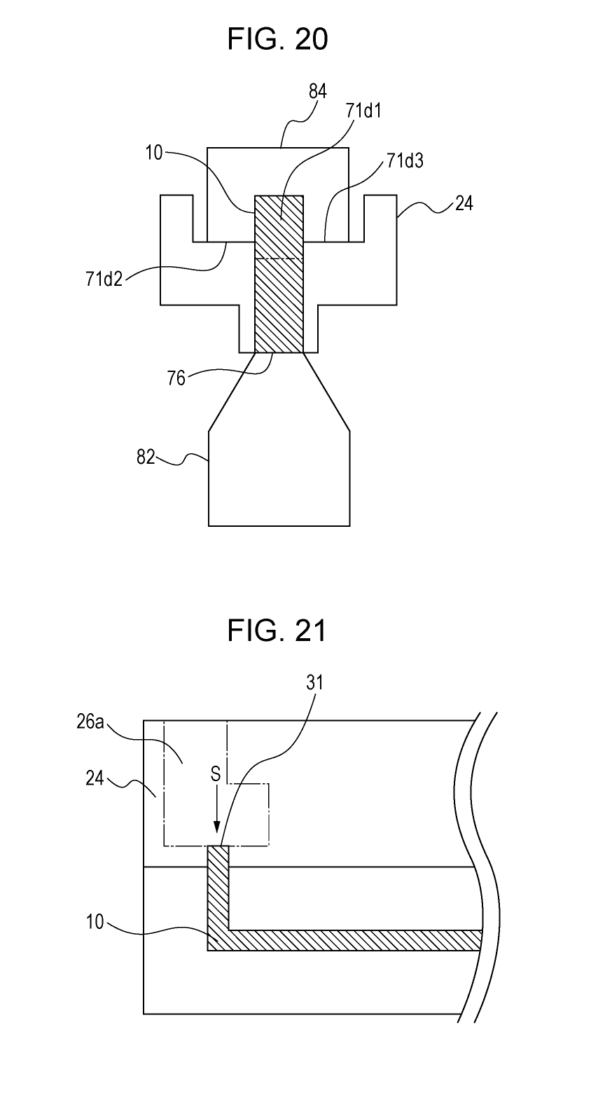

A step of molding the elastomer member 10 is described with reference to FIG. 20.

As illustrated in FIG. 20, the elastomer-member forming portion 71d is disposed on the cleaning container 24. The elastomer-member forming portion 71d has the recess portion 71d1 allowing the elastomer member 10 to be injected therein and includes the contact surfaces 71d2 and 71d3 allowing a mold 84 to come into contact therewith. The inlet 76 having a cylindrical shape and communicating with the recess portion 71d1 in the elastomer-member forming portion 71d is disposed in a predetermined location in the lengthwise direction.

Next, how the elastomer member 10 is molded is described.

In molding the elastomer member 10, the mold 84 cut into the shape of the elastomer member 10 is made to come into contact with the contact surfaces 71d2 and 71d3 in the elastomer-member forming portion 71d in the cleaning container 24. Next, the gate 82 in a resin injection device is made to come into contact with the inlet 76 disposed in one location in the central portion in the lengthwise direction of the cleaning container 24. Then, thermoplastic elastomer resin that is to be the elastomer member 10 is injected from the gate 82 in the resin injection device through the inlet 76 into the cleaning container 24. In this way, the elastomer resin is poured into a space defined by the recess portion 71d1 in the elastomer-member forming portion 71d in the cleaning container 24 and the mold 84. Then, the elastomer resin flows from the central portion in the lengthwise direction toward both ends in the lengthwise direction in the space defined by the recess portion 71d1 in the elastomer-member forming portion 71d and the mold 84, and the elastomer member 10 is injection-molded.

(Shape of Contact Between Elastomer Member and End-Portion Seal Member)

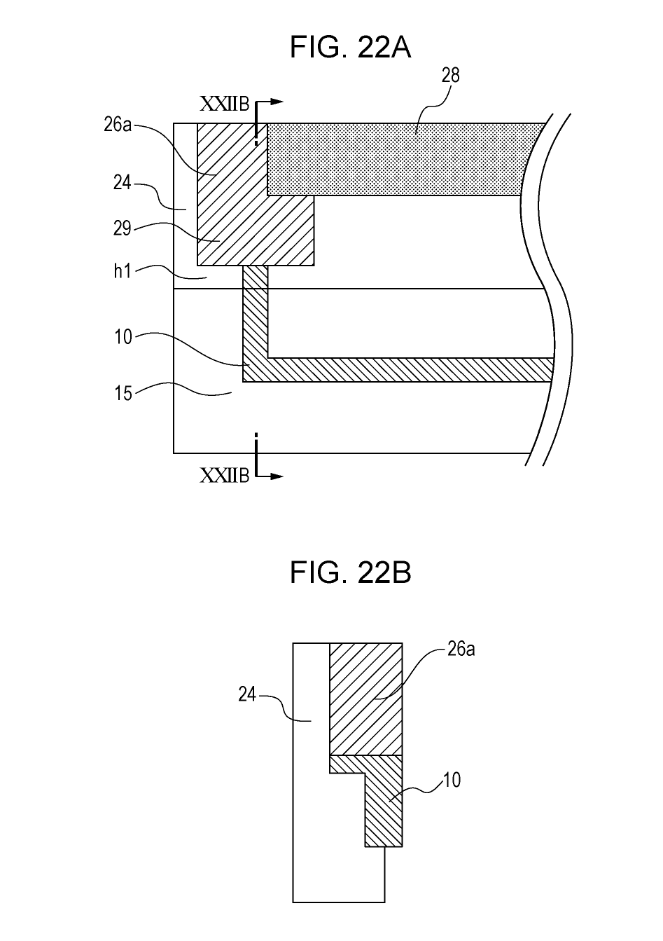

A contact state of the elastomer member 10 and the end-portion seal member 26a when the end-portion seal member 26a is affixed after the elastomer member 10 is molded to the cleaning container 24 is described with reference to FIGS. 21 to 22B.

In the present embodiment, as illustrated in FIG. 21, the elastomer member 10 is molded before the end-portion seal member 26a is affixed to the cleaning container 24. As illustrated in FIGS. 22A and 22B, the end-portion seal member 26a is affixed so as to be in contact with the elastomer member 10. At this time, the end-portion seal member 26a is arranged from the direction indicated by the arrow S in FIG. 21 so as to be in contact with at least the elastomer member 10. In this way, as illustrated in FIGS. 22A and 22B, the end-portion seal member 26a is secured to the cleaning container 24. The end-portion seal member 26a may be arranged so as to be bent toward the elastomer member 10 or dig into the elastomer member 10. In the present embodiment, styrene-based elastomer resin containing carbon black is also used in the elastomer member 10, as in the first embodiment.

(Fusion of Sheet)

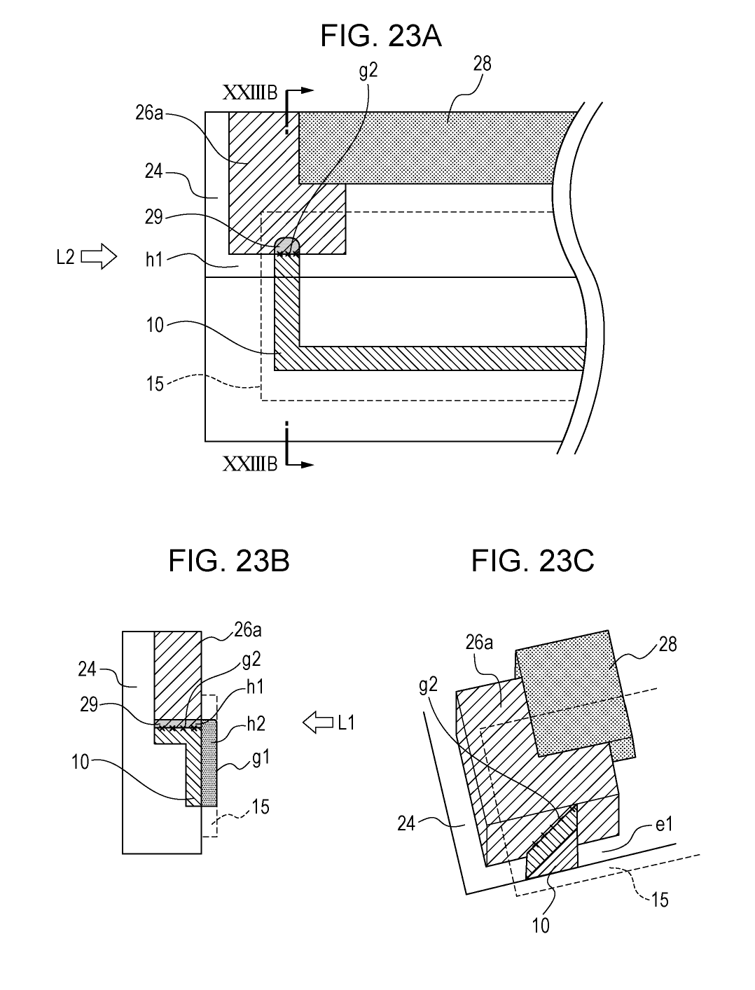

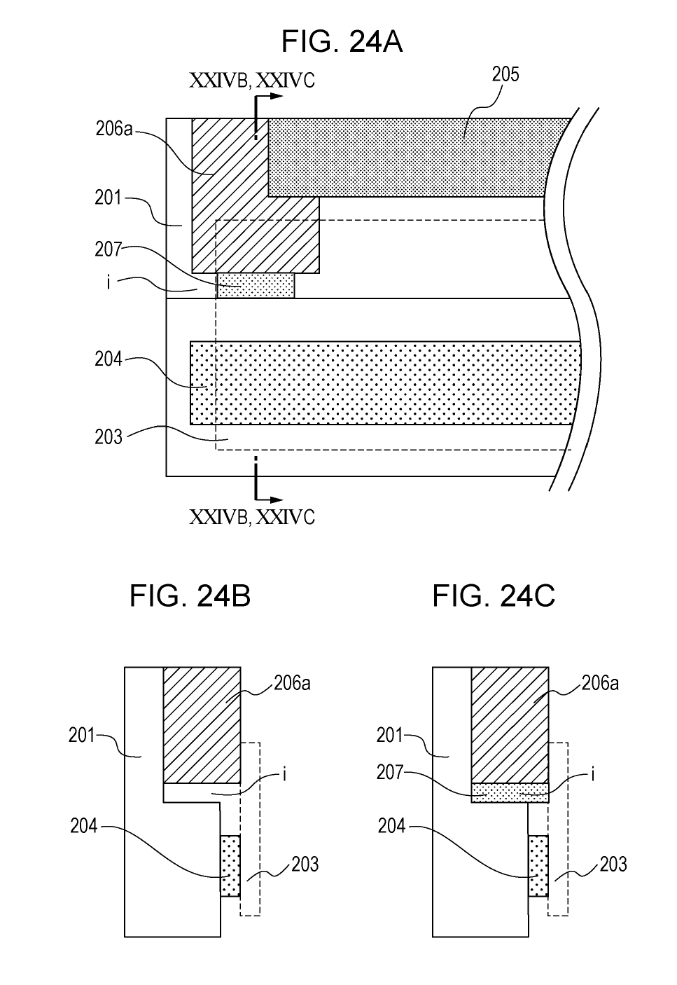

As in the first embodiment, the elastomer member 10 is radiated with the laser, and the scooping sheet 15 is fused to the elastomer member 10. At this time, as illustrated in FIGS. 23A to 23C, in the present embodiment, the elastomer member 10 is radiated with the laser light e, the elastomer member 10 is melted, and the end-portion seal member 26a and the elastomer member 10 are integrated together. The details are described below.

As in the first embodiment, the force receiving portion in the sheet-member attaching surface 24d in the cleaning container 24 is pulled downward by the pull jig 48, and the scooping sheet 15 is overlaid on the elastomer member 10 molded to the warped sheet-member attaching surface 24d so as to be in contact therewith. They are pressed from above the scooping sheet 15 such that the scooping sheet 15 is in contact with the sheet-member attaching surface 24d by using the press jig 45 having transmittance to near infrared radiation. After that, the laser light e is emitted in the state where the sheet-member attaching surface 24d is warped, the elastomer member 10 is melted, and the scooping sheet 15 and the sheet-member attaching surface 24d are bonded.

At this time, in the present embodiment, the thermoplastic elastomer resin melted by the laser light e and forming the elastomer member 10 is impregnated into part of the end-portion seal member 26a, and the mixture portion 29 is formed. Specifically, the elastomer resin that is to be the elastomer member 10 enters the fibrous portion and the porous portion in the end-portion seal member 26a, and the mixture portion 29 is formed. That is, the elastomer resin is made to enter the end-portion seal member 26a, i.e., the fibrous portion and porous portion such that the space contained in the frame formed by the fibers, resin, and other elements is filled therewith, and the mixture portion 29 is formed. This integrates the end-portion seal member 26a and the elastomer member 10 and can seal the gap h1. The scooping sheet 15 and the end-portion seal member 26a can be bonded together. Here, the end-portion seal member 26a on one end and the elastomer member 10 are described. The end-portion seal member 26b on the other end is integrated with the elastomer member 10 in the same way.

In melting the elastomer member 10 and securing the scooping sheet 15, a laser is emitted from a direction (L1) perpendicular to the sheet-member attaching surface 24d. This is useful because after the scooping sheet 15 is attached, the laser can be emitted to the surface where the end-portion seal members 26a and 26b and the elastomer member 10 are in contact with each other from the same direction, and the scooping sheet 15 and the end-portion seal member 26a can be bonded. In other words, it is suitable that the end portion of the elastomer member 10 has a shape at which the surface where the end-portion seal members 26a and 26b and the elastomer member 10 are in contact with each other is visible from the laser emitting direction. Specifically, as illustrated in FIG. 23C, the end portion of the elastomer member 10 may be tapered from the cleaning container 24 toward the scooping sheet 15. In this case, the surface where the end-portion seal members 26a and 26b and the elastomer member 10 are in contact with each other is not perpendicular to but is inclined toward the sheet-member attaching surface 24d. This enables attaching the scooping sheet 15, emitting the laser light e to the surface where the end-portion seal members 26a and 26b and the elastomer member 10 are in contact with each other from the same direction (g2), and bonding the scooping sheet 15 and the end-portion seal member 26a. Aside from this configuration, a configuration in which the elastomer member 10 being bent is in contact with the end-portion seal members 26a and 26b may also be used.

In addition, the light may be emitted to the surface where the end-portion seal members 26a and 26b and the elastomer member 10 are in contact with each other from the lengthwise direction (L2), the elastomer member 10 may be melted, the mixture portion 29 may be formed, and the end-portion seal members 26a and 26b and the elastomer member 10 may be integrated. In the present embodiment, in the step of attaching the scooping sheet 15 to the cleaning container 24, the elastomer resin forming the elastomer member 10 is made to enter the end-portion seal members 26a and 26b, and the end-portion seal members 26a and 26b and the elastomer member 10 are integrated. However, other forms may also be used. The step of making the elastomer resin forming the elastomer member 10 enter the end-portion seal members 26a and 26b and integrating the end-portion seal members 26a and 26b and the elastomer member 10 may be performed as a different step, or only this step may be performed.

(Advantages)

In the configuration according to the present embodiment, because the elastomer member 10 is directly injection-molded to the cleaning container 24 by using the mold, the elastomer member 10 can be formed with high precision. Because the elastomer member 10 is directly injection-molded to the cleaning container 24 by using the mold, the elastomer member 10 can be formed on the cleaning container 24 with high positioning precision through a simple step, in comparison with the related art.

In the present embodiment, the thermoplastic elastomer resin forming the elastomer member 10 is melted and integrated with the end-portion seal members 26a and 26b, and the mixture portion 29 is formed. Thus, the gap h1 between the cleaning container 24 and the end-portion seal members 26a and 26b can be sealed. In addition, the adhesion between the elastomer member 10 and the end-portion seal members 26a and 26b can be improved. In the configuration according to the present embodiment, the gap h1 between the cleaning container 24 and the end-portion seal members 26a and 26b can be sealed by forming the mixture portion 29, the sealing of toner can be enhanced, and the step of applying another member, such as hot-melt adhesive, can be omitted.

In addition, in the present embodiment, the mixture portion 29, in which the elastomer resin forming the elastomer member 10 enters part of the end-portion seal members 26a and 26b, and the scooping sheet 15 are bonded without forming the gap h1 between the cleaning container 24 and the end-portion seal members 26a and 26b. In this way, the gap h2 between the scooping sheet 15 and the end-portion seal members 26a and 26b can be avoided, and toner leakage can be prevented more effectively.

Variations

In the first and second embodiments, the configuration in which, in the cleaning unit 2a, the mixture portion 29 in which the elastomer resin forming the elastomer member 10 enters part of the end-portion seal members 26a and 26b is formed, and the elastomer member 10 and the end-portion seal members 26a and 26b are integrated is described. The embodiments are also applicable to a configuration in which the elastomer member 11 on the developing unit 2b and the end-portion seal members 95a and 95b are integrated. Specifically, melted thermoplastic elastomer resin forming the elastomer member 11 may enter the end-portion seal members 95a and 95b, the melted elastomer resin may be impregnated into the fibrous portion and the porous portion in the end-portion seal members 95a and 95b, and the mixture portion may be formed. That is, the elastomer resin may be made to enter the end-portion seal members 95a and 95b, i.e., the fibrous portion and porous portion such that the space contained in the frame formed by the fibers, resin, and other elements is filled therewith, and the mixture portion 29 may be formed. In this case, the blow-off preventing sheet 16 corresponds to the scooping sheet 15 (thin plate member), the end-portion seal members 26a and 26b correspond to the end-portion seal members 95a and 95b, and the elastomer member 11 corresponds to the elastomer member 10 (resin member). The toner container 70 and the development container 71 correspond to the cleaning container 24 (frame).

In addition, in the first and second embodiments, how the elastomer member 10 molded to the cleaning container 24 in the cleaning unit 2a and the scooping sheet 15 are bonded is described. Other forms may also be used. The embodiments are also applicable to fusion of the elastomer member 11 molded to the development container 71 in the developing unit 2b and the blow-off preventing sheet 16. In this case, after the blow-off preventing sheet 16 is secured to the development container 71 by using the elastomer member 11, the developing-agent bearing member 22 is rotatably attached to the development container 71, and the developing unit 2b is formed. The developing unit 2b is integrated with the cleaning unit 2a with the image bearing member 21 attached thereto. In this way, the cartridge 2 can be manufactured.

With the configuration according to the present invention, a cartridge and unit removably attachable to an image forming apparatus, allowing a member for securing a sheet member to be easily mounted with high precision, and capable of sealing a gap between a frame and the sheet member and preventing leakage of a developing agent and a method for manufacturing the same can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2014/084430, filed Dec. 25, 2014, which is hereby incorporated by reference herein in its entirety.

### INDUSTRIAL APPLICABILITY

With the configuration according to the present invention, a cartridge and unit removably attachable to an image forming apparatus, allowing a member for securing a sheet member to be easily mounted with high precision, and capable of sealing a gap between a frame and the sheet member and preventing leakage of a developing agent and a method for manufacturing the same can be provided.

1. A unit manufacturing method for manufacturing a unit, the unit including
a frame including a developing-agent containing portion,
a rotary member rotatably disposed on the frame,
an end-portion seal member disposed on the frame and being in contact with an end portion in a lengthwise direction of the rotary member,
a thin plate member disposed along the lengthwise direction and including an end in a direction that crosses the lengthwise direction, the end being arranged on the rotary member, and
a resin member that secures the thin plate member to the frame and that is injection-molded to the frame,
the unit manufacturing method comprising:
a first step of arranging the end-portion seal member on the frame;
a second step of making a mold come into contact with the frame, injection-molding resin into a space defined by the frame, the end-portion seal member, and the mold, and forming the resin member;
a third step of placing the thin plate member on the resin member and bonding the thin plate member to the frame by melting the resin member; and
a fourth step of securing the rotary member to the frame,
wherein in the second step, resin forming the resin member is made to enter the end-portion seal member, and the end-portion seal member and the resin member are integrated.

2. The unit manufacturing method according to claim 1, wherein the end-portion seal member includes a porous portion,
in the second step, the resin forming the resin member is made to enter the porous portion, and the end-portion seal member and the resin member are integrated.

3. The unit manufacturing method according to claim 1, wherein the end-portion seal member includes a fibrous portion,
in the second step, the resin forming the resin member is made to enter the fibrous portion, and the end-portion seal member and the resin member are integrated.

4. The unit manufacturing method according to claim 1, wherein in the third step, the thin plate member is bonded to the end-portion seal member by the resin member.

5. The unit manufacturing method according to claim 1, wherein the resin member comprises thermoplastic elastomer resin.

6. The unit manufacturing method for manufacturing the unit according to claim 1, wherein the resin member contains carbon black.

7. The unit manufacturing method according to claim 1, wherein the rotary member comprises an image bearing member,
the developing-agent containing portion comprises a waste-toner chamber that stores a developing agent eliminated from the image bearing member, and
the thin plate member comprises a scooping sheet for preventing the developing agent from leaking from the waste-toner chamber.

8. A cartridge manufacturing method for manufacturing a cartridge removably attachable to a main body of an image forming apparatus, the cartridge manufacturing method including the unit manufacturing method according to claim 7.

9. The unit manufacturing method according to claim 1, wherein the rotary member comprises a developing-agent bearing member, and
the thin plate member comprises a blow-off preventing sheet for preventing the developing agent from leaking from the developing-agent containing portion.

10. A cartridge manufacturing method for manufacturing a cartridge removably attachable to a main body of an image forming apparatus, the cartridge manufacturing method including the unit manufacturing method according to claim 9.
